(19) United States
(12) Patent Application Publication
(10) Pub. No.: US 2010/0017843 A1
(43) Pub. Date: Jan. 21, 2010

(54) Scenario Based Security

(75) Inventors: Israel Hilerio, Kenmore, WA (US); Eric B. Watson, Redmond, WA (US); Bjorn B. Levidow, Bellevue, WA (US); Lingan Satkunanathan, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/147,532

(22) Filed: Jun. 27, 2008

(51) Int. Cl. G06F 17/00; G06F 15/177

(52) U.S. Cl. 726/1; 709/220; 709/224

(57) ABSTRACT

A security management system uses several security scenarios that have rules defining the configuration of system and security components in order to meet a specific security scenario. The rules may include an evaluation of multiple components to give a summary statistic or evaluation, as well as rules that may be used to configure the various components to achieve a desired level of security. A management console may aggregate multiple security scenarios together for administration.

### BACKGROUND

Security management of computer networks can be complex, as many different components may interact to accomplish a goal. The interactions of the various components may be complex and poorly understood by an administrator, especially one that may be less familiar with the complexities of a network environment and the various security threats that may presented to a network.

In a networked environment, several computer devices may share resources using one or more server computers, and each device may have various system configuration components and security components that may affect different security aspects of an individual device or the network as a whole.

### SUMMARY

A security management system uses several security scenarios that have rules defining the configuration of system and security components in order to meet a specific security scenario. The rules may include an evaluation of multiple components to give a summary statistic or evaluation, as well as rules that may be used to configure the various components to achieve a desired level of security. A management console may aggregate multiple security scenarios together for administration.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system with many configurable components.

FIG. 2 is a diagram illustration of an embodiment showing an architecture for a monitoring and controlling system.

FIG. 3 is a timeline illustration of an embodiment showing a method for monitoring and controlling.

### DETAILED DESCRIPTION

A scenario based security system uses a scenario definition that may involve multiple configurable components that may operate together to achieve a specific scenario. In some cases, the scenario definition may be a set of rules that may be used to configure the various components as well as evaluate the current state of the components with respect to the scenario.

A security scenario may be defined for specific goals of a network administrator or business manager. For example, a scenario may be created for securing email messages. Such a scenario may include configuration and evaluation parameters for anti-virus components, firewall components, network gateway components, message logging components, and various other components.

Within a scenario definition, rules or settings may be defined for each configurable component. The scenario definition may incorporate several sets of rules or definitions for status evaluation, general configuration involving multiple components, and specific configuration involving settings of individual components.

Status evaluation definitions may be used to generate overall status summaries of a scenario, as well as other evaluations based on increasing level of details. In an overall status summary, a single metric or set of metrics may be created to give an overall summary of a specific scenario. Some embodiments may have different level of details for status summaries, including evaluations of individual settings of individual components.

General configuration definitions may involve two or more independent components. In many cases, a decision tree or other logic may be used to generate status evaluation by analyzing the presence and configuration of multiple components to aggregate a status metric or evaluation. Some embodiments may include specific sets of rules or other definitions to evaluate the configuration of individual components.

In many embodiments, the scenario definitions may include configuration definitions that may be used to make changes to various components such as security components or system components. In some cases, the scenario definitions may include scripts, executable code, application programming interface calls, or any other mechanism may enable a change to be made to a component. Such scenario definitions may enable an administrator to set a desired security level and have the security system implement the changes to achieve the security level across multiple configurable components.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

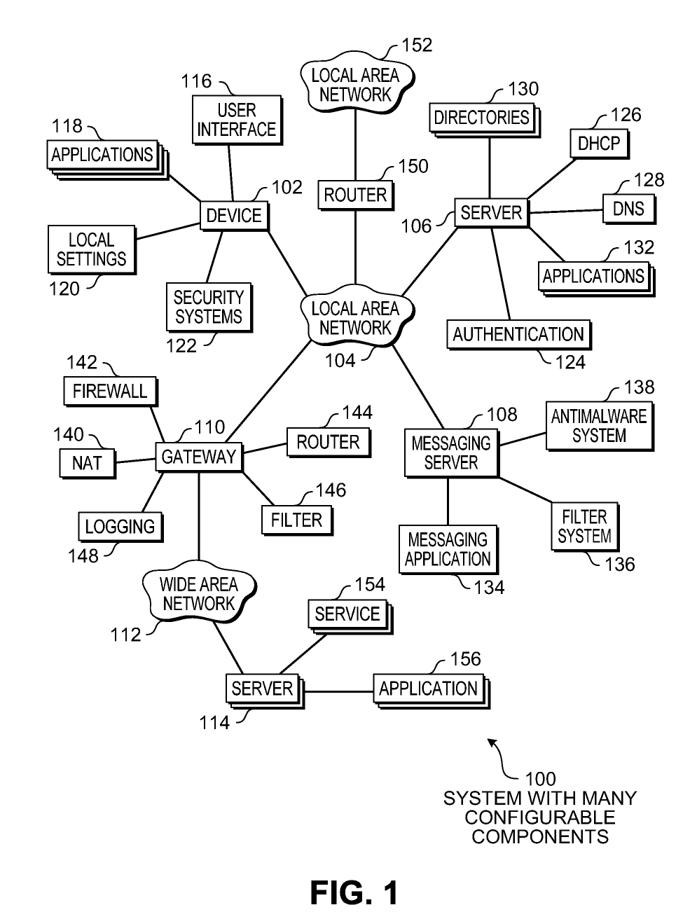

FIG. 1 is a diagram of an embodiment 100 showing a system that may be managed using a scenario based security system. Embodiment 100 is a simplified example of the various components in a typical local area network, and shows some examples of configurable components that may be monitored and configured using a scenario based security system.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

A scenario based security system may be used to monitor, configure, and manage multiple components to achieve various scenarios. The scenarios may address particular goals or operational aspects of a device or group of devices, and may present an organized interface for an administrator.

In many cases, different security and system components may affect different operations of a device. Similarly, the security of a specific operation may be affected by multiple security and system components. For example, an anti-malware system may provide filtering and scanning of a local storage device, incoming and outgoing email, and sometimes provides some firewall functions. Email security, however, may be additionally affected by port settings, content filters, and other components.

In a scenario based security system, a scenario may be defined for many common business goals. Examples of scenarios may include email security, desktop computer security, server computer security, inbound remote access from outside a local network, outbound access to the Internet or other external network, security of remotely accessible applications, security of applications served within a local network, and many other common business or administrative goals.

Each scenario may interact with several different configurable components. The configurable components may include system components, which may be any configurable function, system, application, setting, or other item that may be present on a device. Such system components may be hardware configurable items, operating system items, application or service items, or any other configurable item. Examples of system components may include authorization systems, encryption systems, backup systems, authentication systems, and other systems that may affect security.

A security component may be any type of application, service, system, or function that may perform security related functions. Examples of security components may include applications or systems that perform anti-malware, anti-virus, filtering, and other content analysis functions from a security standpoint. Other security components may include firewall applications and intrusion protection devices.

Some components may be network management devices. Examples of network management devices may be wireless access points, routers, hubs, switches, gateways, authentication systems, domain name system (DNS) servers, dynamic host configuration protocol (DHCP) servers, virtual private network (VPN) devices, logging devices, and other devices or services that enable various network functions.

Each component may affect different scenarios in different manners. For example, a very tightly configured firewall device may protect a network from outside intrusion, but may disable access to a remote service connected over the Internet. In another example, a scenario defining the security of a local device may be have a restrictive authentication setting, but such a setting may disable a backup system that may be related to another scenario.

Scenarios may be defined as independent from other scenarios. In some instances, two or more scenarios may conflict with each other. A scenario management system may present any conflicts to an administrator who may determine how the conflict may be resolved.

A scenario may be defined by a set of rules, processes, decision trees, databases, or other mechanisms that may define the relationships between a security goal and various components that affect the goal. Many scenarios may include monitoring definitions that may identify parameters from various components and define any analysis or summary statistics that may be derived from the parameter values. The scenarios may also include configuration definitions that may enable the components to be changed or configured to achieve a desired status. The desired status may include a set of parameter settings that, when implemented, enable the status to be achieved.

Embodiment 100 illustrates a typical local area network that may have a device 102 connected to the local area network 104, to which various servers 106 and 108 may be also connected. The local area network 104 may have a gateway 110 that may enable connection to a wide area network 112 and another server 114. The wide area network 112 may be the Internet in some embodiments.

In a typical local area network, multiple devices such as device 102 may interact, share services from the servers 106 and 108, run applications across the network, communicate with devices on the wide area network 112, and perform many other interactions. In some embodiments such as large enterprises, a router 150 may connect to another local area network 152 to which many other devices may be connected. Some embodiments may have several hundred or even thousands of devices connected to the local area network 104.

Security management for any scale of computer network can be complex. Even for a single device, many different security and system components may interact to perform different security scenarios. Such complexity may increase significantly when many different devices interact, each posing different security threats and vulnerabilities.

For example, a device 102 may be a desktop computer that has a user interface 116 and may operate several applications 118 locally. The user interface 116 may be used to view and manage a scenario based security management system, in addition to other applications.

Local settings 120 and locally operated security systems 122 may affect various security scenarios. The local settings 120 may include various operating system components and application components that may have parameters that may be monitored and configured. The locally operated security systems 122 may also have parameters that may be monitored and configured. In some embodiments, a parameter may be able to be monitored but not configured, and conversely, some parameters may be configurable but not able to be monitored.

The device 102 may interact with the server 106 to use various services, such as authentication 124, DHCP 126, DNS 128, as well as to access directories 130 and other storage devices, and interact with various applications 132. Each component, such as the services for authentication 124, DHCP 126, DNS 128, directories 130, and the applications 132 may have parameters that may be monitored and configured for individual scenarios.

The messaging server 108 may handle various email and other messaging functions. The messaging server 108 may operate a messaging application 134 that may route, forward, and store messages, as well as provide a mailbox repository that may be accessed by the device 102 using a local application 118. The messaging server 108 may include a content filter system 136 and an anti-malware system 138.

The content filter system 136 may scan messages for inappropriate content, such as undesirable content such as pornography, as well as scanning messages for internally sensitive or classified information such as trade secrets, accounting information, and other sensitive information. The content filter system 136 may have settings or parameters to route or tag messages based on the content of the messages and may store, hold, forward, or destroy messages based on the content.

The anti-malware system 138 may scan incoming and outgoing messages for content that may be harmful to the messaging server 108 or any other device. Malware may include malicious or untrusted executable code, scripts, links to malicious or untrusted websites, or other potentially harmful or destructive material.

The gateway 110 may be a device or system of devices that perform various functions or services to enable communication between the local area network 104 and the wide area network 112. In some embodiments, the gateway 110 may be a single device that performs one or more services or functions. In other embodiments, the gateway 110 may be multiple devices that perform the various services or functions.

The gateway 110 may provide network address translation services (NAT) 140, as well as services for firewall 142, router 144, filter 146, and logging 148. NAT 140 may allow certain devices to have inbound and outbound access to devices in the wide area network 112. In some cases, NAT 140 may redirect connection requests from the wide area network 112 to a specific device within the local area network 104. In other cases, NAT 140 may enable a specific device within the local area network 104 to appear to the wide area network 112 as a device having a specific internet protocol address. The NAT 140 may redirect specific inbound traffic from the wide area network 112 to a specified device within the local area network 104 based on protocol, port, or other characteristics of the traffic.

The firewall 142 may permit or deny certain types of connections across the gateway 110. In some cases, the firewall 142 may block connections that use specific ports or are made by specific devices or use specific protocols. In many cases, a firewall 142 may permit most outbound traffic but may deny most inbound traffic.

The filter 146 may analyze inbound and outbound traffic for content as well as malware. In some embodiments, the filter 146 may perform similar functions as the filter system 136 and anti-malware system 138 for the messaging server 108.

In many embodiments, a gateway 110 may have a service for logging 148. The logging 148 service may keep a record of communication requests and other traffic across the gateway 110, including inbound and outbound traffic.

Many embodiments may enable a device 102 to communicate with a remote server 114 to access various services 154 and applications 156. The services 154 and applications 156 may perform any type of function, including various security functions.

Each item described in embodiment 100 may have one or more parameters that may affect different security aspects of the overall system. The parameters may be monitored and controlled in some cases to manage the security of the system.

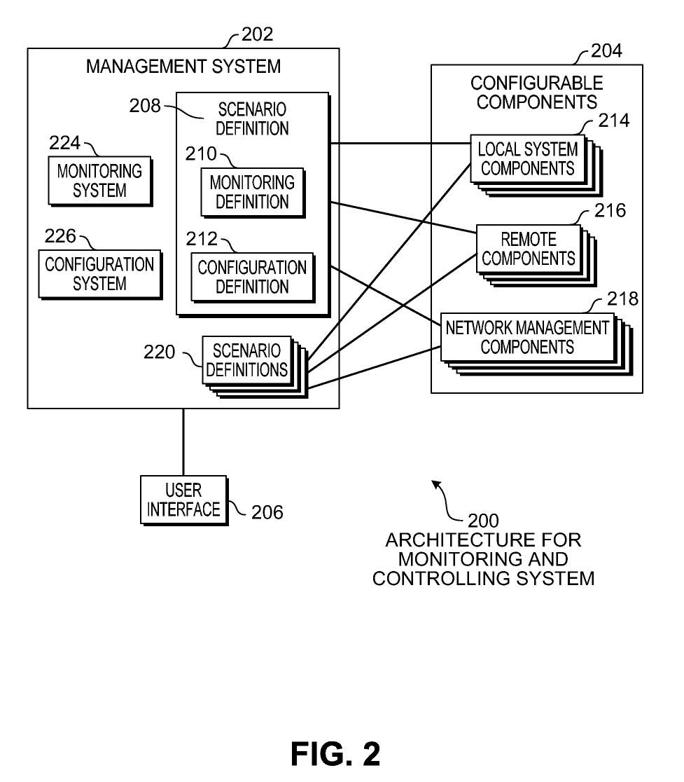

FIG. 2 is a diagram illustration of an embodiment 200 showing the architecture of a management system. Embodiment 200 is a simplified illustration of the various components that may interact to enable monitoring and controlling security aspects of a system using scenario definitions.

Embodiment 200 illustrates one type of system architecture that may be used for scenario based management. Other embodiments may have different constructions and may use different terminology to accomplish similar functions.

Embodiment 200 illustrates a management system 202 that may interact with various configurable components 204. The management system 202 may interact with a user via a user interface 206.

In many embodiments, the management system 202 may be an application or group of applications that may reside on one or more devices. The management system 202 may have access to various scenario definitions 208 and 220. Scenario definition 208 is illustrated as containing a monitoring definition 210 and a configuration definition 212.

The scenario definitions 208 and 220 may use any type of expression or mechanism to define a scenario. Many embodiments may use rules, tables, databases, logic trees, workflows, scripts, executable expressions, or other expressions to define how various configurable components 204 may be configured to perform a specific scenario.

The scenario definitions 208 and 220 may define a specific set of monitored parameters and configurable parameters that may address a specific security scenario. A scenario may address any type of function or activity that may be performed within a network environment from a security aspect, and may coordinate several different components.

A scenario may be created to address specific functions that may span several configurable components. In many cases, the functions may be defined in terms of user operations or business operations. By defining a specific business function or goal, several configurable components may be configured to enable the business function or goal.

Scenarios may be created for various communication functions, such as protecting email communications, securing instant messaging, enabling outbound access to the Internet, securing inbound remote access to a local area network, securing desktop computers from attacks inside and outside a local area network, securing server computers from unauthorized access both inside and outside a network, securing authorized access to applications delivered inside and outside a network, and other functions.

For each scenario, a group of configurable components 204 may be identified that may affect the goal of a particular scenario. The configurable components 204 may include local system components 214, remote components 216, and network management components 218.

Local system components 214 may be any setting, application, service, function, or changeable item that may be accessible or operable on a local device. Such components may include operating system components, settings for various applications, network interface settings, configuration of local security applications and services, or any other parameter or configurable item that may be locally accessible and locally changed.

Remote components 216 may include items accessible over a local area network. Such items may include applications, services, functions, and other components on server devices, peer devices, client devices, or other devices within a local area network, or similar components available through the Internet or other wide area network.

Network management components 218 may include any type of network appliance such as routers, switches, hubs, gateways, firewall devices, wired or wireless access points, or any other network device. Many such devices may have configurable components that may be monitored and configured to achieve a specific scenario.

A scenario definition may consolidate several parameters from multiple configurable components to achieve a desired security goal. The scenario may enable parameters associated with the various configurable components to be gathered, aggregated, and presented as a single status or set of status items, and may also enable those parameters to be changed or configured across multiple components in a single operation from the user's standpoint.

The management system 202 may have a monitoring system 224 that may use a monitoring definition 210 to collect, consolidate, and display status information from multiple components. The monitoring system 224 may actively and passively communicate with each component defined in the monitoring definition 210 to gather a current status of specified parameters. In an active communication, the monitoring system 224 may transmit a request or perform a query against the monitored component. In a passive communication, the monitoring system 224 may gather a parameter without having to communicate with the monitored component. In an example of passive communication, the monitoring system 224 may read a configuration file for an application to determine how the application is configured.

After collecting values for the various parameters, the monitoring system 224 may perform various analyses, generate summary statistics, identify potential problems, rate the current status, or perform other functions on the received data. In many embodiments, the summary statistics may involve consolidating parameter values from operationally independent configurable components.

The configuration system 226 may actively change or configure several of the configurable components 204 to achieve a desired status. An administrator or user may select a desired status which may contain configurable parameters from multiple components. The configuration system 226 may cause the configurable parameters on each of the components to be changed to achieve the desired status.

In many embodiments, a scenario definition may contain scripts, executable code, and other mechanisms to perform queries or to cause parameters to be changed. For example, a scenario definition may include an executable portion of code that may communicate with an application over an application programming interface to first query a parameter and then to cause the parameter within the application to change. Because a scenario definition may interface with many different applications, services, and functions as configurable components, each component may have a different mechanism with which the management system 202 may interface.

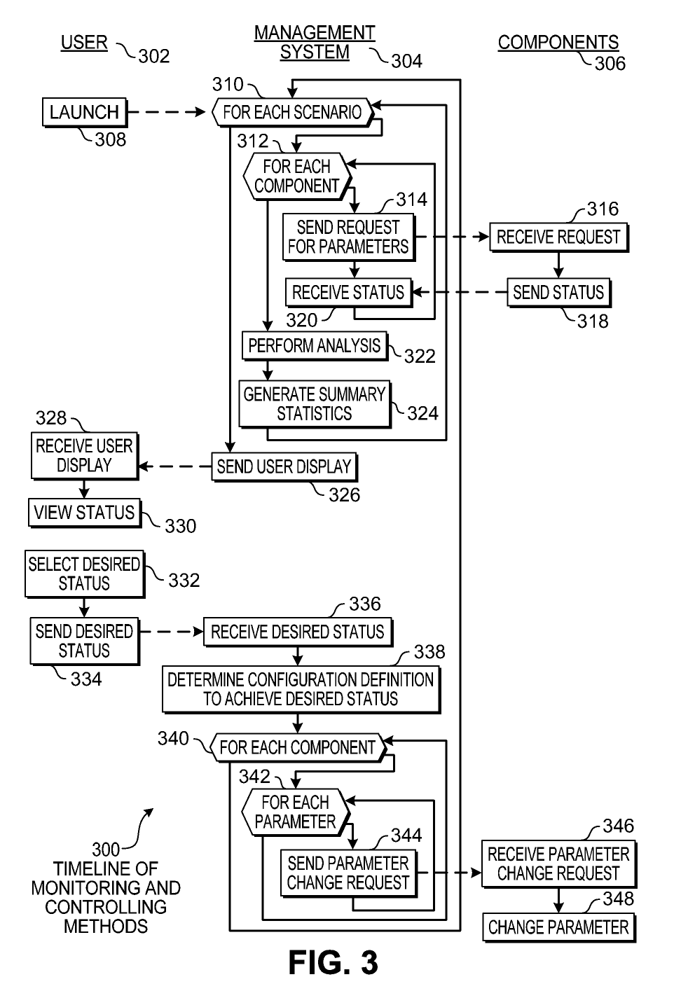

FIG. 3 is a flowchart illustration of an embodiment 300 showing a method for monitoring and controlling configurable components using scenarios. Embodiment 300 is constructed as a timeline diagram, with operations of a user 302 in the left column, operations of a management system 304 in the center column, and operations of the configurable components 306 in the right column.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 is a simplified example of the interactions between a user 302, a management system 304, and configurable components 306. A scenario definition may be used to gather and analyze parameters from multiple components to determine a current status of the scenario, as well as define the parameter settings that may be changed to achieve a desired status.

In block 308, the user 302 may launch the management system 304. In many embodiments, the management system 304 may be operable on a local device, or may be operated on a remote server and the user interface may be presented on a local device. In one such embodiment, a server may operate a management system and a user may access the management system through a web browser. The management system may be operable on a server within a local area network or on a server accessed via the Internet.

In many embodiments, a management system 304 may be configured with multiple scenarios. In such embodiments, scenarios may be defined for specific business goals or other security goals or functions. For example, a scenario may be created for email security and other scenarios for inbound remote network access, outbound Internet access, and security for applications provided within a local area network. The several scenarios may correspond closely or roughly with security goals determined for an organization.

For each scenario in block 310, and for each component in block 312 within the scenario, a request for parameter values may be transmitted in block 314 to a component 306. The component 306 may receive the request in block 316 and send a status for the parameters in block 318. The status may be received in block 320 and the process may return to block 312 for another component.

In the loop defined by block 312, parameters may be gathered from each component. In many cases, two or more components may be queried.

The query and response sequence of blocks 314 through 320 are illustrative of an active query mechanism. Any type of data gathering technique may be used, including passive queries of configuration files or some other mechanism that does not involve communication with the component. In some cases, complex scripts, executable programs, or other mechanisms may be used to gather the parameters in block 320.

After gathering parameters from multiple components in block 312, an analysis may be performed in block 322 and summary statistics for the parameters may be generated in block 324. The process may return to block 310 to perform a data gathering and analysis process for another scenario.

In many embodiments, the methods, algorithms, and techniques for analyzing and summarizing the parameters may be defined within a scenario definition.

After each scenario is analyzed in block 310, a user display may be generated and transmitted in block 326. The user may receive the user display in block 328 and view the status of the various scenarios in block 330.

In many embodiments, multiple scenarios may be displayed, each with a summary statistic to indicate if the scenario is properly implemented. For example, an embodiment may include a name of a scenario, such as “Email Security” along with a summary statistic that may have a green, yellow, and red color indicator. Many embodiments may enable a user to select the scenario and display a deeper layer of parameters or summary statistics that were used to generate the overall statistic.

When a current status is not the desired status, a user may select a desired status in block 332. The desired status may be an overall level of protection or other summary parameter that may represent a group of settings for several different components. The desired status may be an option that may be defined within a scenario definition.

The desired status may be sent by the user in block 334 and received in block 336 by the management system 304. The management system 304 may determine a configuration definition in block 338 that may achieve the desired status. The configuration definition in block 338 may be a rule, entry in a database, or some other mechanism by which a desired set of parameters may be determined. In block 338, the parameters for each affected component may be determined.

For each component in block 340, and for each parameter in block 342, a parameter change request may be transmitted in block 344. The parameter change request may be received by the component in block 346 and the parameter may be changed in block 348. The process may return to block 342 to process additional parameters. After each parameter is processed in block 342, the next component is similarly processed in block 340.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
receiving a first scenario definition comprising:
at least one configurable parameter for each of a plurality of configurable components;
at least one configuration definition based on a first subset of said configurable parameters, said configuration definition comprising at least one desired status;
performing a configuration function comprising:
receiving a first desired status;
determining a first configuration definition comprising said first desired status;
for each of said configurable components having at said at least one configurable parameter in said first configuration definition, causing said configurable parameter to match said first configuration definition.

2. The method of claim 1 further comprising:
said first scenario definition further comprising:
at least one monitored parameter for each of said plurality of configurable components;
performing a monitoring function comprising:
for each of said configurable components, determining a current value for each of said monitored parameter; and
displaying at least one of said current value.

3. The method of claim 2, said monitoring function further comprising:
generating at least one summary statistic; and
displaying said at least one summary statistic.

4. The method of claim 1, at least one of said configurable components being on a server device.

5. The method of claim 1, at least one of said configurable components being on a remote device.

6. The method of claim 5, said remote device being a server device.

7. The method of claim 5, said remote device being a network management device.

8. The method of claim 1, said scenario definition being for one scenario of a group composed of:
email security;
outbound internet access;
inbound remote access to a network;
desktop system security;
server system security; and
application security.

9. A system comprising:
a plurality of security scenario definitions, each of said security scenario definitions having at least one configuration parameter from a plurality of configurable components and comprising at least one desired status having a set of configuration parameter settings;
a monitoring system configured to determine a status of each of said configuration parameters;
a user interface configured to display said status; and
a configuration system configured to receive a desired status, select a first security scenario definition from said plurality of security scenario definitions comprising said desired status, and causing said configurable parameters to match said set of configuration parameter settings for said first security scenario.

10. The system of claim 9, at least one of said configurable components being on a remote device.

11. The system of claim 10, said remote device being a server device within a local area network.

12. The system of claim 10, said remote device being a server device outside a local area network.

13. The system of claim 10, said remote device being a network management device.

14. The system of claim 9, said configuration system further configured to receive a first desired setting for a first configuration parameter and causing said first configuration parameter to match said first desired setting.

15. The system of claim 9, each of said plurality of security scenario definitions being independent of each other.

16. The system of claim 9, said configuration system further configured to cause said configurable parameters to match said set of configuration settings by launching a script.

17. The system of claim 9, said configuration system further configured to cause said configurable parameters to match said set of configuration settings by launching an executable program configured to change at least one of said configuration settings.

18. A method comprising:
selecting a first scenario definition from a plurality of scenario definitions, each of said scenario definitions comprising:
at least one configurable parameter for each of a plurality of configurable components;
at least one configuration definition based on a first subset of said configurable parameters, said configuration definition comprising at least one desired status;
transmitting said selection of said first scenario definition;
receiving a display comprising a current value for said first subset of configurable parameters corresponding to said first scenario definition;
selecting a first desired status;
transmitting said first desired status such that said for each of said configurable components having at said at least one configurable parameter in said first configuration definition, said configurable parameter is caused to match said first configuration definition.

19. The method of claim 18, said first desired status being transmitted at least in part to a remote server computer.

20. The method of claim 18, said configurable component being a network management device.
